(19) United States
(12) Patent Application Publication
(10) Pub. No.: US 2026/0259040 A1
(43) Pub. Date: Sep. 3, 2026

(54) COMPENSATION OF OPERATIONALLY INDUCED THERMAL DEFORMATIONS IN THE MANUFACTURING PROCESS OF AN OPTICAL ELEMENT UNDER THERMAL CONTROL DURING OPERATION

(71) Applicant: Carl Zeiss SMT GmbH, Oberkochen (DE)

(72) Inventors: Johannes SCHURER-KOCH, Heidenheim an der Brenz (DE); Maike LORENZ, Aalen (DE); Andre DIRAUF, Aalen (DE); Toralf GRUNER, Aalen (DE); Norman BAER, Aalen (DE)

(21) Appl. No.: 19/661,979

(22) Filed: Apr. 29, 2026

Related U.S. Application Data
(63) Continuation of application No. PCT/EP2024/080589, filed on Oct. 29, 2024.

(30) Foreign Application Priority Data
Oct. 30, 2023 (DE) 10 2023 210 727.9

(51) Int. Cl. G01B 11/255; B29D 11/00; G02B 5/08; G06F 30/10; G06F 119/08

(52) U.S. Cl. CPC G01B 11/255; B29D 11/00951; G06F 30/10; G02B 5/0891; G06F 2119/08

(57) ABSTRACT

A method for producing an optical element (1) for an optical system, the optical element having a target surface shape (1a) and/or a target optical effect during the operation of the optical system. The optical element (1) has a mean operating temperature T_{X̅} which during the operation of the optical system is controlled by at least one thermal manipulator (2). Also disclosed are an optical element for an optical system, and an optical system for a semiconductor technology apparatus.

### CROSS-REFERENCE TO RELATED APPLICATION

This is a Continuation of International Application PCT/EP2024/080589, which has an international filing date of Oct. 29, 2024, and the disclosure of which is incorporated in its entirety into the present Continuation by reference. This Continuation also claims foreign priority under 35 U.S.C. § 119(a)-(d) to and also incorporates by reference, in its entirety, German Patent Application DE 10 2023 210 727.9 filed Oct. 30, 2023.

### FIELD

The invention relates to a method for producing an optical element for an optical system, the optical element having a target surface shape and/or a target optical effect during the operation of the optical system. Furthermore, the invention relates to an optical element for an optical system, and to an optical system for a semiconductor technology apparatus.

### BACKGROUND

For example, semiconductor technology apparatuses include projection exposure apparatuses which are used to produce microstructured or nanostructured components for microelectronics or microsystems technology. In order to be able to exactly produce structures of the order of nanometres and micrometres, a corresponding projection exposure apparatus must be capable of exactly imaging structures contained on a reticle onto a substrate such as a wafer. However, the optical elements in the projection exposure apparatus are heated on account of the radiation load from the operating light of the projection exposure apparatus, whereby aberrations might arise. Driven by current demands for increased throughput, the radiation source is becoming ever more powerful, especially in extreme ultraviolet (EUV) projection exposure apparatuses, and so the power within the optical systems of the projection exposure apparatus is increasing as a result. Since even the best coatings of EUV optical units do not attain reflectivities of near 100%, the upshot of this is an increase in the amount of power absorbed in the optical elements. This in turn leads to thermally induced deformations, which can lead to a significant deterioration in the imaging quality of the optical systems.

The anticipation and compensation of deformations that arise during the operation of an EUV projection exposure apparatus on account of the elevated temperature was already attempted within the manufacturing process in DE 10 2010 030 913 A1. However, the optical elements of an optical system in a projection exposure apparatus are not usually illuminated constantly over time. Instead, there are significant fluctuations in the operating temperature that depend on the operation of the scanner. Thus, the temperature load on the optical elements and the aberration arising therefrom may vary, especially due to altered illumination settings and/or the imaging of different reticles.

### SUMMARY

One object addressed by the present invention is therefore developing a method for producing an optical element for an optical system, the optical element having a target surface shape and/or a target optical effect during the operation of the optical system, such that the optical element reliably has the target surface shape and/or the target optical effect in various use scenarios of the optical system, especially in different illumination settings. A further object addressed by the present invention is providing an advantageous optical element and an advantageous optical system.

According to a first teaching of the present invention, the aforementioned objects are addressed for a method for producing an optical element for an optical system, the optical element having a target surface shape and/or a target optical effect during the operation of the optical system, due to the optical element having a mean operating temperature T_{X̅} which during the operation of the optical system is controlled by at least one thermal manipulator, and the method comprises the following steps:
determining the actual surface shape and/or the actual optical effect of the optical element at the mean operating temperature T_{X̅}, with the actual surface shape and/or the actual optical effect of the optical element at the mean operating temperature T_{X̅} deviating from a target surface shape and/or the target optical effect at the mean operating temperature T_{X̅}, and
machining the optical element to adapt the actual surface shape and/or the actual optical effect of the optical element to the target surface shape and/or the target optical effect at the mean operating temperature T_{X̅} in accordance with the determined actual surface shape and/or the actual optical effect of the optical element at the mean operating temperature T_{X̅}.

The optical element can be an optical element for an optical system in a semiconductor technology apparatus. For example, the optical element is a reflective optical element, e.g. a mirror or a mask. The optical element might comprise a substrate with a substrate surface. For example, the substrate might comprise SiSic, Zerodur® by Schott AG or ULE® by Corning Inc. and/or quartz glass or any other type of glass. Furthermore, the optical element might comprise a coating. In particular, the optical element comprises a coating suitable for reflecting light from the EUV wavelength range (1-20 nm), in particular 13.5 nm.

The optical system can be a projection system of a semiconductor technology apparatus, for example a lithography lens. The optical system comprises at least one optical element. By preference, the optical system comprises a plurality of optical elements. The optical system might comprise an arrangement of optical elements serving to manipulate and/or shape light, in order to create, magnify and/or correct images. For example, the optical system might comprise various optical elements such as lens elements, mirrors, prisms and/or filters, which are positioned in a specific arrangement to focus, deflect, scatter and/or filter light beams.

The optical element at least substantially has a target surface shape and/or a target optical effect during the operation of the optical system. In particular, during the operation of the optical system, the optical element at least substantially has a target surface shape and/or a target optical effect at the mean operating temperature TX̅. For example, the target surface shape and/or the target optical effect of the optical element during the operation of the optical system might be predetermined by an optical design. For example, it is feasible that the target surface shape and/or the target optical effect of the optical element during the operation of the optical system at least substantially corresponds to the surface shape or the target optical effect according to the underlying optical design.

The optical element has a mean operating temperature TX̅ during the operation of the optical system. The mean operating temperature TX̅ is controlled by at least one thermal manipulator during the operation of the optical system. The at least one thermal manipulator can control the distribution of the operating temperature TX̅ over time t and optionally as a function of location r. During the operation of the optical system and with the aid of the at least one thermal manipulator, the operating temperature can be brought to and/or kept at a desired target temperature in particular. For example, the mean operating temperature TX̅ corresponds at least substantially to a target temperature. The at least one thermal manipulator in particular can be used to control the mean operating temperature TX̅ so that the mean operating temperature TX̅ at least substantially corresponds to the target temperature, in particular corresponds to the target temperature±0.5 K, in particular ±<0.5 K. For example, it is feasible that the mean operating temperature TX̅ corresponds to the target temperature±0.5 K, in particular ±<0.5 K. For example, the target temperature and/or the mean operating temperature TX̅ are between 25° C. and 30° C. In particular, the mean operating temperature TX̅ is kept constant by the at least one thermal manipulator during the operation of the optical system. For example, the at least one thermal manipulator might be a heater, in particular an infrared (IR) heater, or a sector heater, or a water cooler. In particular, the thermal manipulator is suitable for controlling the temperature of the optical element locally such that a temperature profile chosen so that the temperature profile is the same for all the various illumination settings is created over the optical element. By preference, the temperature profile can be selected such that the temperature profile over the optical element has at each location on the optical element a temperature greater than or equal to the maximum temperature created in the optical element by radiation from a radiation source, for example a semiconductor technology apparatus, for one of the illumination settings of an illumination unit and/or for an imaging setting of the optical system. The temperature profile can be kept constant over time during the operation of the optical system, in particular the semiconductor technology apparatus comprising the optical system. For example, electromagnetic radiation can be used to control the temperature of the optical element. The radiation intensity can be selected such that the profile of the absorbed radiation intensity over the optical element has at each location on the optical element a radiation intensity greater than or equal to the maximum absorbed radiation intensity created in the optical element by radiation from a radiation source for one of the illumination settings of the illumination unit and/or for an imaging setting of the optical system, with the profile of the absorbed radiation intensity in particular being kept constant over time during the operation of the optical system, in particular the semiconductor technology apparatus.

The method can comprise a determination of the actual surface shape of the optical element at the mean operating temperature TX̅. As an alternative to that or in addition, the method can comprise a determination of the actual optical effect of the optical element at the mean operating temperature TX̅. The determined actual surface shape and/or the determined actual optical effect of the optical element at the mean operating temperature TX̅ can deviate from in particular the target surface shape and/or the target optical effect at the mean operating temperature TX̅. For example, a determination can be understood to mean an ascertainment, measurement and/or calculation or simulation.

The method also comprises machining of the optical element to adapt the actual surface shape and/or the actual optical effect of the optical element to the target surface shape and/or the target optical effect at the mean operating temperature TX̅ in accordance with the determined actual surface shape and/or the actual optical effect of the optical element at the mean operating temperature TX̅. The optical element can be machined on the basis of the determined actual surface shape at the mean operating temperature TX̅, such that the actual surface shape at least substantially corresponds to the target surface shape at the mean operating temperature TX̅. The optical element can be machined on the basis of the determined actual optical effect, such that the actual optical effect at the mean operating temperature TX̅ at least substantially corresponds to the target optical effect at the mean operating temperature TX̅. For example, machining of the optical element might comprise polishing of the optical element.

It has transpired that the method allows production of an optical element which reliably has the target surface shape and/or target optical effect in various use scenarios for the optical system. The target surface shape and/or target optical effect of the optical element at the mean operating temperature TX̅ can be reliably provided during the production of the optical element as a result of the mean operating temperature TX̅ of the optical element being controlled, in particular kept constant, with the aid of the at least one thermal manipulator during the operation of the optical system. The operating temperature of an optical element increases predominantly due to the radiation from the radiation source should no thermal manipulator be present in an optical system, and the operating temperature may vary for different illumination settings, which for example are adapted by the user of the optical system depending on the structure required. Thus, thermally induced deformations during the operation of the optical element, in particular optical system, are generally time dependent. However, the mean operating temperature TX̅ of the optical element can be advantageously controlled, in particular kept constant, with the aid of the at least one thermal manipulator. The at least one thermal manipulator allows the operating temperature to be modified such that a required correction of a thermal deformation becomes less sensitive to fluctuations in parameters such as pressure, cooling water temperatures, material properties, in particular the zero-crossing temperature (ZCT) of the thermal expansion, and/or powers. In particular, the at least one manipulator can be designed such that the corrected temperature distribution works as universally as possible for users during operation. For example, the method allows targeted reworking of optical elements during the production. The method for machining the optical element can serve to correct the optical element, in particular to correct the surface shape and/or optical effect of the optical element.

According to an advantageous configuration of the method according to the first teaching, the actual surface shape and/or the actual optical effect of the optical element at the mean operating temperature TX̅ is determined by simulation. In particular, the actual surface shape and/or the actual optical effect of the optical element at the mean operating temperature TX̅ can be determined with the aid of the simulation without there being any actual need to set the mean operating temperature TX̅ during the production of the optical element. In other words, the would-be surface shape and/or the would-be optical effect that the optical element would have at the mean operating temperature TX̅ can be determined with the aid of the simulation. For example, the actual surface shape and/or the actual optical effect of the optical element can be determined with the aid of a finite element simulation.

For example, spatially resolved material data for the optical element at a measurement temperature T_{M}, which deviates from the mean operating temperature T_{X̅} and is a manufacturing temperature T_{F} in particular, can be initially determined as a basis for the simulation. For example, spatially resolved material data for the optical element can be determined by optical interferometry and/or ultrasound measurements of the optical element at the measurement temperature T_{M}. In particular, it is possible to take account of realistic material models, for example thermal hysteresis, nonlinear expansion properties and/or specially measured homogeneity and/or inhomogeneity data. For example, the optical element might comprise a material which has a homogeneous and/or inhomogeneous coefficient of thermal expansion that differs from zero, in particular a glass ceramic such as Zerodur® or titanium-doped quartz glass such as ULE, and/or has other local variations, for example in respect of refractive index. These properties of the optical element, in particular of the material, can be taken into account during the simulation for example.

According to a further advantageous configuration of the method according to the first teaching, the determination of the actual surface shape and/or of the actual optical effect of the optical element at the mean operating temperature T_{X̅} can comprise a measurement of the actual surface shape and/or of the actual optical effect of the optical element at at least one measurement temperature T_{M} and an interpolation or extrapolation to the actual surface shape and/or the actual optical effect of the optical element at the mean operating temperature T_{X̅}. In this case, interpolation or extrapolation to the actual surface shape and/or actual optical effect of the optical element at the mean operating temperature T_{X̅} is implemented on the basis of the measured actual surface shape and/or actual optical effect of the optical element at the at least one measurement temperature T_{M} in particular. In the case of extrapolation, function values outside of an interval can be determined at least approximately on account of the known function values within this interval. In the case of interpolation, a continuous interpolant which maps the measured values can be determined on the basis of at least two measured values.

For example, the actual surface shape and/or the actual optical effect of the optical element can be measured at a first measurement temperature TM1 and at least one second measurement temperature TM2, and the actual surface shape and/or the actual optical effect of the optical element at the mean operating temperature TX̅ can be interpolated or extrapolated on the basis of the actual surface shape and/or actual optical effect of the optical element as measured at the first measurement temperature TM1 and the second measurement temperature TM. In particular, the at least one measurement temperature TM deviates from the mean operating temperature TX̅. For example, it is feasible that the actual surface shape and/or the actual optical effect of the optical element is measured at a first measurement temperature TM1, the first measurement temperature TM1 being 22° C.+5 K, and at a second measurement temperature TM2, the second measurement temperature TM2 being 22° C.+10 K. Using this as a starting point, it is possible for example to interpolate to 22° C.+7 K or extrapolate to 22° C.+12 K. For example, the at least one measurement temperature TM might have been set with the aid of a measuring device comprising at least one thermal manipulator, with the optical element being heated, preferably only temporarily, to the at least one measurement temperature TM with the aid of the thermal manipulator. It is also feasible that the at least one measurement temperature TM is the manufacturing temperature TF.

According to a further advantageous configuration of the method according to the first teaching, the determination of the actual surface shape and/or of the actual optical effect of the optical element at the mean operating temperature TX̅ can comprise a measurement of the actual surface shape and/or of the actual optical effect of the optical element at the mean operating temperature TX̅. For example, it is feasible that the actual surface shape and/or the actual optical effect of the optical element is measured at an ambient temperature that corresponds to the mean operating temperature TX̅. To this end, the surroundings in which the measurement is implemented, for example a cleanroom, can be heated to the mean operating temperature TX̅.

Alternatively, it is feasible that the actual surface shape and/or the actual optical effect of the optical element is measured at the mean operating temperature TX̅ with the aid of a suitable measuring device. For example, the measuring device might comprise at least one thermal manipulator, with the optical element being heated, preferably merely temporarily, to the mean operating temperature TX̅ with the aid of the thermal manipulator. For example, it is feasible for the measuring device to comprise an optical heat source, for example a heater, in particular an IR heater, an oven or a bath with a controllable water temperature. The optical element can be heated with the aid of the measuring device, such that the mean operating temperature TX̅ is reached. In particular, the thermal manipulator of the optical system is reproduced to the best possible extent in the measuring device. Moreover, the measuring device might comprise measuring equipment, in particular a measurement sensor, for measuring the surface shape and/or for measuring the optical effect of the optical element.

The surface shape and/or the optical effect of the optical element can be measured while the optical element is heated at the mean operating temperature TX̅ at the same time, for example with an IR heater. It is also feasible that respective measurements are implemented with an activated and/or deactivated thermal manipulator, with the result that the difference between the measurements can be worked into the optical element, in particular into the surface of the optical element. The surface shape of the optical element can be measured in absolute terms or relative to a reference surface. In particular, the measuring device might comprise measuring equipment for measuring the surface shape of the optical element in absolute terms or relative to a reference surface. For example, the measurement might be made relative to a reference surface, and the machining of the optical element might comprise working the difference with respect to the reference surface into the surface of the optical element. For example, the procedure is repeated until convergence, i.e. until the measured surface corresponds to the reference surface.

According to a further advantageous configuration of the method according to the first teaching, the optical element can be machined at a manufacturing temperature TF. For example, the manufacturing temperature might deviate from the mean operating temperature TX̅ by more than 0.5 K, preferably by more than 1 K, more preferably by more than 2 K, and particularly preferably by more than 5 K. It is also feasible that the manufacturing temperature TF deviates by 10 to 20 K from the mean operating temperature TX̅. For example, the manufacturing temperature TF can be room temperature. For example, the manufacturing temperature TF is 22° C. For example, the mean operating temperature TX̅ might be set within the production of the optical element only during the determination, in particular measurement, of the surface and/or the optical effect of the optical element. The determination of the actual surface shape and/or of the actual optical effect of the optical element at the mean operating temperature TX̅ and the machining of the optical element, in particular at the manufacturing temperature TF, to adapt the actual surface shape and/or the actual optical effect of the optical element to the target surface shape and/or the target optical effect at the mean operating temperature TX̅ can be implemented iteratively in particular.

According to a further advantageous configuration of the method according to the first teaching, the optical element can be machined at the mean operating temperature TX̅. For example, it is feasible that the optical element is machined at an ambient temperature that corresponds to the mean operating temperature TX̅. To this end, the surroundings in which the machining is implemented, for example a cleanroom, can be heated to the mean operating temperature TX̅. Thereby, the mean operating temperature TX̅ can already be set during the manufacture of the optical element. This allows the optical element to be manufactured directly with compensation. Moreover, thanks to machining the optical element at the expected mean operating temperature TX̅, there are no periods of wait for the temperature control for measurement purposes or inaccuracies on account of a waiting time that is too short and an incomplete warming through of the optical element. However, in this context it should be observed that all process validation measurements must also be made at the mean operating temperature TX̅.

According to a further advantageous configuration of the method according to the first teaching, the method can comprise a determination of a difference between the actual surface shape and/or the actual optical effect of the optical element at the mean operating temperature TX̅ and the target surface shape and/or the target optical effect of the optical element at the mean operating temperature TX̅. For example, the method can comprise a determination of a deviation of the actual surface shape and/or the actual optical effect of the optical element at the mean operating temperature TX̅ from the target surface shape and/or the target optical effect of the optical element at the mean operating temperature TX̅. In particular, the method can comprise a determination of a required surface correction to adapt the actual surface shape and/or the actual optical effect of the optical element at the mean operating temperature TX̅ to the target surface shape and/or the target optical effect of the optical element at the mean operating temperature TX̅. In particular, machining of the optical element can be dependent on the determined difference between the actual surface shape and/or the actual optical effect of the optical element at the mean operating temperature TX̅ and the target surface shape and/or the target optical effect of the optical element at the mean operating temperature TX̅. For example, it is feasible that the method comprises a determination of a compensation which improves a target function for optimizing an optical effect, in particular an aberration state, of the optical element, in particular of the optical system, vis-à-vis a state without compensation, for example due to an expected surface shape modification as a consequence of the temperature difference being determined with the opposite sign.

According to a further advantageous configuration of the method according to the first teaching of the present invention, the method can comprise compensating the difference between the actual surface shape and the target surface shape and/or between the actual optical effect and the target optical effect in part by correction and/or at least one further manipulator. The at least one further manipulator can be a rigid body manipulator in particular. For example, it is feasible that there is a partial correction of the difference by correction, for example a reticle or semiconductor substrate stage available in the optical system, and/or at least one further manipulator, which for example brings about rigid body movements and/or deformations of optical elements.

The machining of the optical element to adapt the actual surface shape and/or the actual optical effect of the optical element to the target surface shape and/or the target optical effect at the mean operating temperature TX̅ can take account of the partially implemented compensation of the difference between the actual surface shape and the target surface shape and/or between the actual optical effect and the target optical effect by correction and/or the at least one further manipulator. For example, it is feasible that a predefined target function is calculated from one or more residual error images and that the required compensation, in particular the surface change, in the optical element is determined such that at least one improvement in the target function is obtained.

According to a second teaching of the present invention, the aforementioned objects are addressed for a method for producing an optical element for an optical system, the optical element having a target surface shape and/or a target optical effect during the operation of the optical system, due to the optical element having a mean operating temperature T_{X̅} which during the operation of the optical system is controlled by at least one thermal manipulator, and the method comprises the following steps:
determining the actual surface shape and/or the actual optical effect of the optical element at a manufacturing temperature T_{F},
determining a change in the actual surface shape and/or in the actual optical effect of the optical element on account of a temperature difference T_{X̅}−T_{F} between the manufacturing temperature T_{F} and the mean operating temperature T_{X̅}, and
machining the optical element to adapt the actual surface shape and/or the actual optical effect of the optical element to the target surface shape and/or the target optical effect at the mean operating temperature T_{X̅} in accordance with the determined actual surface shape and/or the actual optical effect at the manufacturing temperature T_{F} and in accordance with the determined change in the actual surface shape and/or in the actual optical effect on account of the temperature difference T_{X̅}−T_{F} between the mean operating temperature T_{X̅} and the manufacturing temperature T_{F}.

The method can comprise a determination of the actual surface shape of the optical element at a manufacturing temperature T_{F}. As an alternative to that or in addition, the method can comprise a determination of the actual optical effect of the optical element at a manufacturing temperature T_{F}. In particular, the manufacturing temperature T_{F} deviates from the mean operating temperature T_{X̅}. The method can moreover comprise a determination of a change in the actual surface shape of the optical element on account of a temperature difference T_{X̅}−T_{F} between the manufacturing temperature T_{F} and the mean operating temperature T_{X̅}. As an alternative to that or in addition, the method can comprise a determination of a change in the actual optical effect of the optical element on account of a temperature difference T_{X̅}−T_{F} between the manufacturing temperature T_{F} and the mean operating temperature T_{X̅}.

The method also comprises machining of the optical element to adapt the actual surface shape and/or the actual optical effect of the optical element to the target surface shape and/or the target optical effect at the mean operating temperature T_{X̅}. Machining of the optical element can be dependent on the determined actual surface shape and/or the determined actual optical effect at the manufacturing temperature T_{F} and dependent on the determined change in the actual surface shape and/or in the actual optical effect on account of the temperature difference T_{X̅}−T_{F} between the mean operating temperature T_{X̅} and the manufacturing temperature T_{F}.

According to an advantageous configuration of the method according to the second aspect, the determination of the change in the actual surface shape and/or in the actual optical effect of the optical element on account of the temperature difference T_{X̅}−T_{F} between the manufacturing temperature T_{F} and the mean operating temperature T_{X̅} comprises a determination of a difference between the actual surface shape and/or the actual optical effect of the optical element at the manufacturing temperature T_{F} and the target surface shape and/or the target optical effect of the optical element at the mean operating temperature T_{X̅}. In particular, the method can comprise a determination of a required surface correction to adapt the actual surface shape and/or the actual optical effect of the optical element at the mean operating temperature T_{X̅} to the target surface shape and/or the target optical effect of the optical element at the mean operating temperature T_{X̅}.

According to a further advantageous configuration of the method according to the second aspect, the change in the actual surface shape and/or in the actual optical effect of the optical element is determined on the basis of a mathematical model for determining the local deformation in the case of a change in temperature. For example, the method can comprise a determination of the surface shape and/or of the optical effect of the optical element at the mean operating temperature TX̅, in contrast to the actual surface shape and/or the actual optical effect of the optical element at the manufacturing temperature TF, on the basis of a simulation calculation. To determine the change in the actual surface shape and/or in the actual optical effect of the optical element, the surface shape and/or the optical effect of the optical element at the mean operating temperature TX̅ can be simulated, in particular with the aid of a finite element simulation. In other words, the would-be surface shape and/or the would-be optical effect of the optical element at the mean operating temperature TX̅ can be determined with the aid of the simulation without there being any need to set the mean operating temperature TX̅. In this case too, spatially resolved material data can be determined initially as a basis for the simulation, for instance by optical interferometry and/or ultrasound measurements of the optical element at the manufacturing temperature TF. The simulation can be based on a use scenario, which brings about a static temperature distribution in the optical element. The surface shape of the optical element at the mean operating temperature TX̅ can then be determined with the aid of the mathematical model, in particular the finite element simulation. For example, conclusions about the optical effect of the optical element at the mean operating temperature TX̅ can also be drawn in that case as a result. It is feasible that the optical effect, for example an optical aberration effect, of the optical element at the mean operating temperature TX̅ is determined, in particular calculated, with the aid of a simulation.

For example, it is feasible that the method according to the first teaching and/or the second teaching comprises a determination of a compensation which improves a target function for optimizing an optical effect, in particular an aberration state, of the optical element, in particular of the optical system, vis-à-vis a state without compensation, for example due to an expected surface shape modification as a consequence of the temperature change being determined with the opposite sign.

The method according to the first teaching and/or second teaching can comprise a calculation of the temperature distribution in the optical element. For example, simulations allow the prevalent temperature distribution in the optical element on average to be calculated on the basis of the predicted operation of the optical element. From this, it is possible to calculate a surface deformation which must be taken into account when producing the optical element. The method might comprise a calculation of the deformation of the surface of the optical element and/or an extraction of the surface correction required. In this case, it is possible to take account of the local variation of material parameters within the optical element, e.g. the refractive index variation and/or the variation in the coefficient of thermal expansion. Especially if the material of the optical element, for example Zerodur®, exhibits thermal hysteresis, it is also possible when choosing the optimal compensation for the operation to take account of, at least in part, the time profile of temperature and deformation during the operation of the optical element.

According to a further advantageous configuration of the method according to the second teaching of the present invention, the method can comprise compensating the determined change in the actual surface shape and/or in the actual optical effect of the optical element in part by correction and/or at least one further manipulator. The at least one further manipulator can be a rigid body manipulator in particular. For example, it is feasible that there is a partial correction of the change by, for example a reticle or semiconductor substrate stage available in the optical system, and/or at least one further manipulator, which for example brings about rigid body movements and/or deformations of optical elements.

Machining the optical element to adapt the actual surface shape and/or the actual optical effect of the optical element to the target surface shape and/or the target optical effect at the mean operating temperature TX̅ can take account of the partially implemented compensation of the determined change in the surface shape and/or in the optical effect of the optical element by correction and/or the at least one further manipulator. For example, it is feasible that a predefined target function is calculated from one or more residual error images and that the required compensation, in particular the surface change, in the optical element is determined such that at least one improvement in the target function is obtained.

According to an advantageous configuration of the method according to the second teaching of the present invention, the optical element can be machined at the manufacturing temperature TF. For example, the manufacturing temperature might deviate from the mean operating temperature TX̅ by more than 0.5 K, preferably by more than 1 K, more preferably by more than 2 K, and particularly preferably by more than 5 K. It is also feasible that the manufacturing temperature TF deviates by 10 to 20 K from the mean operating temperature TX̅. For example, the manufacturing temperature TF can be room temperature. For example, the manufacturing temperature TF is 22° C. The determination of the actual surface shape and/or of the actual optical effect of the optical element at the manufacturing temperature TF and the machining of the optical element at the manufacturing temperature TF to adapt the actual surface shape and/or the actual optical effect of the optical element to the target surface shape and/or the target optical effect at the mean operating temperature TX̅ can be implemented iteratively in particular.

According to an advantageous configuration of the method according to the first or second teaching of the present invention, the method can comprise a determination of the optical effect of the optical system. In particular, the method can comprise a determination of an aberration and/or the wavefront of the optical system. The method can comprise a determination of the target surface shape and/or the target optical effect of the optical element at the mean operating temperature TX̅ in accordance with the determined optical effect of the optical system. For example, it is feasible that specific or all optical elements, degrees of freedom and/or manipulators are taken into account to determine the target surface shape and/or the target optical effect of the optical element, in particular to determine a required surface correction of the optical element. For example, the method can serve to reduce the thermally induced aberrations during the operation of the optical system. For example, selected or all manipulators of the optical system can be taken into the account within the optimization. In particular, this includes thermal manipulators, with the aid of which it is possible to adapt the temperature of optical elements during operation. For example, a direct consequence of the concept is that all manipulators are relieved from the travel for compensating the mean absolute value during operation, and so travel is made available for an improved corrective effect.

In particular, the method can serve to take account of the mean deformation in the surface design of the optical element and thus serve the compensation of thermal aberrations. In this case, the compensation need not be restricted to a specific optical element; instead, the thermally induced aberrations can also be corrected on one or more other optical elements. In other words, an error need not necessarily be corrected on the same optical element where it occurs. Machining the optical element to adapt the surface shape and/or the optical effect of the optical element to the target surface shape and/or the target optical effect at the mean operating temperature TX̅ can for example take account of an already implemented partial compensation of an aberration in the optical system, for example by at least one correction and/or at least one manipulator. For example, it is feasible that the method comprises a determination of a compensation which improves a target function for optimizing the aberration state of the optical system with the optical element vis-à-vis a state without compensation. In principle, specifics of an individual optical system and/or optical element, for example material parameters such as ZCT and/or reflectivities, can be taken into account, allowing a reduction in performance fluctuations.

According to a third teaching of the present invention, the aforementioned objects are addressed for an optical element for an optical system, the optical element having a target surface shape and/or a target optical effect during the operation of the optical system, due to the optical element having a first surface shape at a measurement temperature TM, in particular a manufacturing temperature TF, and having the target surface shape and/or the target optical effect at a mean operating temperature TX̅, with the optical element during the operation of the optical system having the mean operating temperature TX̅ which is controlled by at least one thermal manipulator. In particular, the optical element is produced according to a method according to the first or the second teaching of the present invention.

According to a fourth teaching of the present invention, the aforementioned objects are addressed by an optical system for a semiconductor technology apparatus, comprising: at least one optical element according to the third teaching, and at least one thermal manipulator which controls the mean operating temperature TX̅ of the optical element. For example, the semiconductor technology apparatus can be a projection exposure apparatus, a wafer inspection apparatus or a mask inspection apparatus.

According to an advantageous configuration of the optical system according to the fourth teaching, the provision of a predetermined state in which the mean operating temperature TX̅ of the optical element and the mean operating temperature TX̅ of at least one further optical element deviate from one another by at least 1 K leads to a reduction of at least one aberration by at least 20%, preferably at least 25%, and particularly preferably at least 30% in comparison with a state in which the optical element and the at least one further optical element have at least substantially the same temperature.

For example, the at least one aberration can be a distortion, a focal error, an astigmatism, a coma, a specific value in the wavefront expansion according to Zernike polynomials and/or an RMS (root mean square) value of the wavefront deviation, for example in its field dependence. In particular, the aberration can be a Zernike RMS5 and/or, depending on the use of the semiconductor technology apparatus for a predetermined combination of illumination and structure, the distortion (overlay) and/or the target/actual deviation of the focus. Moreover, this can be a stray light contribution (flare). The at least two optical elements can be, in particular, the first and the last optical element in the optical system and/or the first optical element with at least virtually perpendicular incidence and the largest optical element, preferably with grazing incidence.

The exemplary configurations of the present invention described hereinabove in this description should also be understood as disclosed in all combinations with one another. The individual features of each teaching can in each case be combined with any desired or all features of the other teachings. In particular, features, in particular steps, of the method according to the first teaching can be combined with features, in particular steps, of the method according to the second teaching. For example, in the measurement-based method, it is possible to already start with an actual surface which is already very close to the optimal design state as a result of a simulation-based correction or as a result of manufacture in the heated state. Such a combination allows the reduction of possible errors in the process chain. A further feasible combination would lie in assisting the simulation-based correction through measurements, due to the measurements serving as sampling points for interpolation or extrapolation or simulation calibration. This is of particular interest in the case in which the desired operating state is not available in the measurement.

Further configurations and advantages of the invention will be explained in conjunction with the drawing in the following detailed description of a few exemplary embodiments of the present invention.

### BRIEF DESCRIPTION OF THE DRAWING

Exemplary embodiments and variants of the invention are explained in detail below with reference to the drawing. The aspects of the disclosure can be understood best from the following detailed description in conjunction with the appended figures. The figures are schematic and simplified; they only show details to improve the understanding of the claims, while other details are omitted. The same reference numerals are used throughout for identical or corresponding parts. The individual features of each aspect can in each case be combined with any desired or all features of the other aspects. These and other aspects, features and/or technical effects are evident from the figures described below and are clarified by said figures, in which

FIGS. 1A, 1B show an optical element, respectively, at a manufacturing temperature TF and at an operating temperature TB, said element having been produced using a method according to the prior art,

FIGS. 2A, 2B show an optical element, respectively, at a manufacturing temperature TF and at a mean operating temperature TX̅, said element having been produced according to a method according to the first or second teaching of the present invention, and

FIG. 3 shows a measuring device for determining a surface shape and/or an optical effect of an optical element at a mean operating temperature T_{X̅} within the scope of a method according to the first teaching.

### DETAILED DESCRIPTION

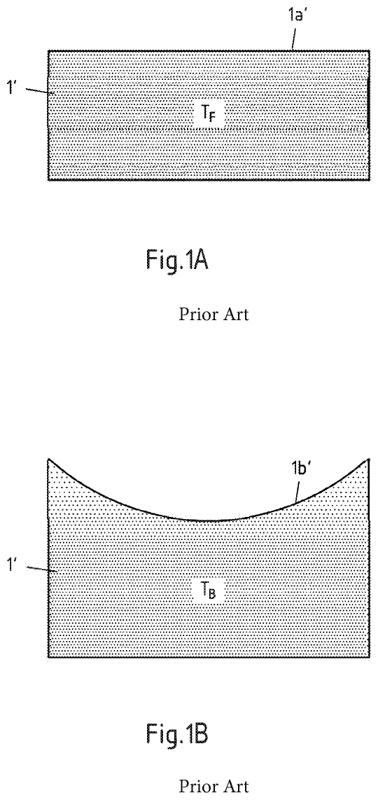

An optical element 1′ from the prior art and designed as an EUV mirror is shown in FIG. 1A. The optical element 1′ was manufactured at a manufacturing temperature TF of approximately 22° C. The optical element 1′ has a target surface shape 1a′ at the manufacturing temperature TF. While the surface shape of the optical element 1′ was polished optimally with respect to the design surface within the scope of the manufacturing process, the surface shape changes due to thermal deformations in regions of elevated temperature (brighter regions) during the operation of an optical system in which the optical element 1′ is used, as shown in FIG. 1B. At an operating temperature TB of >22° C., for example 30° C., the optical element 1′ has a surface shape 1b′ that deviates from the target surface shape 1a′.

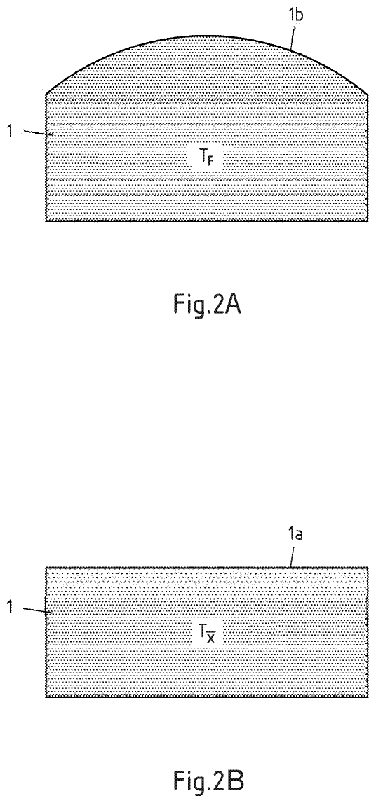

An optical element 1 is shown at a manufacturing temperature TF in FIG. 2A and at a mean operating temperature TB in FIG. 2B, said element having been produced according to a method according to the first or second teaching of the present invention. While the optical element 1 has a deviation from the target surface shape according to the optical design of the optical element during the production at the manufacturing temperature TF, the optical element 1 has the target surface shape 1a at the mean operating temperature TX̅. The thermal deformation on account of the difference between the mean operating temperature TX̅ and the manufacturing temperature TF was already taken into account during the production.

For example, the optical element 1 was produced according to a method for producing an optical element for an optical system, the optical element having a target surface shape and/or a target optical effect at a mean operating temperature TX̅ controlled by at least one thermal manipulator 2 during the operation of the optical system and said method comprising a determination of the actual surface shape 1b and/or the actual optical effect of the optical element 1 at a manufacturing temperature TF, a determination of the change in the actual surface shape 1b and/or in the actual optical effect of the optical element 1 on account of the temperature difference TX̅−TF between the manufacturing temperature TF and the mean operating temperature TX̅, and machining of the optical element 1 to adapt the actual surface shape 1b and/or the actual optical effect of the optical element 1 to the target surface shape 1a and/or the target optical effect at the mean operating temperature TX̅ in accordance with the determined actual surface shape 1b and/or the actual optical effect at the manufacturing temperature TF and in accordance with the determined change in the actual surface shape 1b and/or in the actual optical effect on account of the temperature difference TX̅−TF between the mean operating temperature TX̅ and the manufacturing temperature TF.

In this case, the change in the actual surface shape 1b and/or in the actual optical effect of the optical element 1 was determined based on a mathematical model for determining the local deformation in the case of a change in temperature. For example, it is feasible that the method comprises a calculation of the temperature distribution, a calculation of the deformations and/or an extraction of the required surface correction.

In order to determine the temperature distribution with the aid of the heat equation (1), given below, the power source, the thermal coupling to the surroundings of the optical element 1 and/or thermal material properties, for example, are determined. Based on the power incident on the optical element 1, the material properties can be used to calculate the absorbed power at each location on the surface of the optical element 1. This yields the source f_{S}(\vec{r}, t) for the heat equation, where f_{V}(\vec{r}, t) is zero in this case. Knowledge of the surroundings of the optical element 1, e.g. air or other gases, pressure, distances from possible adjacent components and/or components in direct contact with the optical element, in particular contact faces, materials, allows the thermal boundary conditions of the heat equation (1) to be determined according to equation (2), given below. The thermal material parameters of the optical element, such as heat capacity c, thermal conductivity λ and density ρ, are also required.

To solve the equation, the finite element method (FEM), for example, can be used to discretize the 3-D space. The heat equation for the temperature distribution T(\vec{r}, t) as a function of location \vec{r} and time t is given by

$$\frac{\partial T ( \vec{r} , t )}{\partial t} - α Δ T ( \vec{r} , t ) = {f}_{v} ( \vec{r} , t ) \qquad ( 1 )$$

with the thermal conductivity

$$α = \frac{λ}{ρ c}$$

and the volume source f_{V}(\vec{r}, t). As a result of the surface stress f_{S}(\vec{r}, t), the boundary condition moreover applies to all surface points \vec{r}_{O} on the optical element:

$$- λ {∇}_{n} T ( {\vec{r}}_{O} , t ) = μ ( T ( {\vec{r}}_{O} , t ) - {T}_{0} ) + {f}_{S} ( {\vec{r}}_{O} , t ) \qquad ( 2 )$$

where T₀ is the temperature of the adjacent material, μ is the heat transfer coefficient and ∇ₙ is the derivative in the surface normal direction. The change in heat due to thermal radiation is not listed explicitly here; in general, it can also be taken into account.

The relative change in volume per volume element can be determined based on the temperature and/or the temperature distribution and with the aid of the coefficient of thermal expansion. Thereupon, the point of equilibrium of the mechanical forces, which arise both due to mechanical boundary conditions and the temperature gradients, is determined with the aid of the material parameters, for example density, Young's modulus and/or Poisson number. Thus, the deformation is obtained at each point in the optical element 1. The points on the optical surface \vec{r}_{OF} in particular are relevant for the optical effect in the case of a mirror.

The extent to which the design surface must be modified can be determined using the calculated deformation in the normal direction at each location \vec{r}_{OF} of the optical surface dO(\vec{r}_{OF}). One option in this case would lie in ablating the inverse deformation—dO(\vec{r}_{OF}). However, it is often more advantageous to first consider the available manipulators: If the rigid body degrees of freedom of the optics part are provided with manipulators, it might be advisable to initially correct the calculated surface deformation K[dO(\vec{r}_{OF})] and only subsequently ablate the remaining component from the surface.

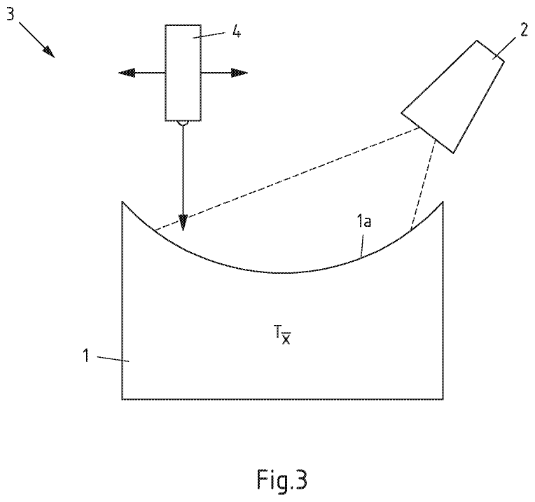

Alternatively, it is feasible that the optical element 1 was produced according to a method for producing an optical element for an optical system, the optical element having a target surface shape and/or a target optical effect at a mean operating temperature T_{X̅} controlled by at least one thermal manipulator 2 during the operation of the optical system, according to the first teaching. For example, the method comprises a determination the actual surface shape 1b and/or the actual optical effect of the optical element 1 at the mean operating temperature T_{X̅}, with the actual surface shape 1b and/or the actual optical effect of the optical element 1 at the mean operating temperature T_{X̅} deviating from the target surface shape 1a and/or the target optical effect at the mean operating temperature T_{X̅}, and machining of the optical element 1 to adapt the actual surface shape 1b and/or the actual optical effect of the optical element 1 to the target surface shape 1a and/or the target optical effect at the mean operating temperature T_{X̅} in accordance with the determined actual surface shape 1b and/or the actual optical effect of the optical element 1 at the mean operating temperature T_{X̅}. In this case, the actual surface shape 1b and/or the actual optical effect of the optical element 1 at the mean operating temperature T_{X̅} was measured with the aid of a measuring device 3 as shown in FIG. 3, for example.

FIG. 3 shows a measuring device 3 for determining an actual surface shape 1b and/or the actual optical effect of the optical element 1 at the mean operating temperature T_{X̅}. The measuring device 3 comprises a thermal manipulator 2, with the optical element 1 during its production being temporarily heated to the mean operating temperature T_{X̅} with the aid of the thermal manipulator 2. For example, the thermal manipulator 2 is an IR heater. Moreover, the measuring device 3 comprises measuring equipment 4, in particular a measurement sensor, for measuring the surface shape 1a of the optical element 1. The surface shape 1a of the optical element 1 can be measured while the optical element 1 is heated at the mean operating temperature T_{X̅} at the same time. It is also feasible that respective measurements are implemented with an activated and deactivated thermal manipulator 2, with the result that the difference between the measurements can be worked into the optical element 1, in particular into the surface 1a of the optical element 1.

The above description of various embodiments has been given by way of example. From the disclosure given, those skilled in the art will not only understand the present invention and its attendant advantages but will also find apparent various changes and modifications to the structures and methods disclosed. The applicant seeks to cover all such changes and modifications as fall within the spirit and scope of the invention, as defined by the appended claims, and equivalents thereof.

What is claimed is:

1. A method for producing an optical element for an optical system, the optical element having a target surface shape and/or a target optical effect during the operation of the optical system, wherein the optical element has a mean operating temperature which during the operation of the optical system is controlled by at least one thermal manipulator, the method comprising:
determining an actual surface shape and/or the actual optical effect of the optical element at the mean operating temperature, with the actual surface shape and/or the actual optical effect of the optical element at the mean operating temperature deviating from the target surface shape and/or the target optical effect at the mean operating temperature, and
machining the optical element to adapt the actual surface shape and/or the actual optical effect of the optical element to the target surface shape and/or the target optical effect at the mean operating temperature in accordance with the determined actual surface shape and/or the actual optical effect of the optical element at the mean operating temperature.

2. The method according to claim 1, wherein
the actual surface shape and/or the actual optical effect of the optical element at the mean operating temperature is determined by a simulation.

3. The method according to claim 1, wherein
said determining of the actual surface shape and/or of the actual optical effect of the optical element at the mean operating temperature comprises a measurement of the actual surface shape and/or of the actual optical effect of the optical element at at least one measurement temperature and an interpolation or extrapolation to the actual surface shape and/or the actual optical effect of the optical element at the mean operating temperature.

4. The method according to claim 1, wherein,
said determining of the actual surface shape and/or of the actual optical effect of the optical element at the mean operating temperature comprises a measurement of the actual surface shape and/or of the actual optical effect of the optical element at the mean operating temperature.

5. The method according to claim 1, wherein
the optical element is machined at a manufacturing temperature.

6. The method according to claim 1, wherein
the optical element is machined at the mean operating temperature.

7. The method according to claim 1, further comprising
determining a difference between the actual surface shape and/or the actual optical effect of the optical element at the mean operating temperature and the target surface shape and/or the target optical effect of the optical element at the mean operating temperature.

8. The method according to claim 1, further comprising:
compensating the difference between the actual surface shape and the target surface shape and/or between the actual optical effect and the target optical effect in part by correction and/or at least one further manipulator, and
machining the optical element to adapt the actual surface shape and/or the actual optical effect of the optical element to the target surface shape and/or the target optical effect at the mean operating temperature while taking account of the partially implemented compensation of the difference between the actual surface shape and the target surface shape and/or between the actual optical effect and the target optical effect with a correction and/or the at least one further manipulator.

9. The method according to claim 8, wherein
the at least one further manipulator is a rigid body manipulator.

10. A method for producing an optical element for an optical system, the optical element having a target surface shape and/or a target optical effect during the operation of the optical system, wherein the optical element has a mean operating temperature which during the operation of the optical system is controlled by at least one thermal manipulator, the method comprising:
determining the actual surface shape and/or the actual optical effect of the optical element at a manufacturing temperature,
determining a change in the actual surface shape and/or in the actual optical effect of the optical element on account of a temperature difference between the manufacturing temperature and the mean operating temperature, and
machining the optical element to adapt the actual surface shape and/or the actual optical effect of the optical element to the target surface shape and/or the target optical effect at the mean operating temperature in accordance with the determined actual surface shape and/or the actual optical effect at the manufacturing temperature and in accordance with the determined change in the actual surface shape and/or in the actual optical effect on account of the temperature difference between the mean operating temperature and the manufacturing temperature.

11. The method according to claim 10, wherein
said determining of the change in the actual surface shape and/or in the actual optical effect of the optical element on account of the temperature difference between the manufacturing temperature and the mean operating temperature comprises a determination of a difference between the actual surface shape and/or the actual optical effect of the optical element at the manufacturing temperature and the target surface shape and/or the target optical effect of the optical element at the mean operating temperature.

12. The method according to claim 10, wherein
the change in the actual surface shape and/or in the actual optical effect of the optical element is determined based on a mathematical model for determining the local deformation in in response to a change in temperature.

13. The method according to claim 10, further comprising:
compensating the determined change in the actual surface shape and/or in the actual optical effect of the optical element in part with a correction and/or at least one further manipulator, and
machining the optical element to adapt the actual surface shape and/or the actual optical effect of the optical element to the target surface shape and/or the target optical effect at the mean operating temperature in accordance with the partially implemented compensation of the determined change in the actual surface shape and/or in the actual optical effect of the optical element with the correction and/or the at least one further manipulator.

14. The method according to claim 13, wherein
the at least one further manipulator is a rigid body manipulator.

15. The method according to claim 10, wherein
the optical element is machined at the manufacturing temperature.

16. The method according to claim 1, further comprising:
determining an optical effect of the optical system, and
determining the target surface shape and/or the target optical effect of the optical element at the mean operating temperature in accordance with the determined optical effect of the optical system.

17. The method according to claim 10, further comprising:
determining an optical effect of the optical system, and
determining the target surface shape and/or the target optical effect of the optical element at the mean operating temperature in accordance with the determined optical effect of the optical system.

18. An optical element for an optical system, the optical element having a target surface shape and/or a target optical effect during the operation of the optical system, wherein the optical element has a first surface shape at a measurement temperature and has the target surface shape and/or the target optical effect at a mean operating temperature, with the optical element during the operation of the optical system having the mean operating temperature which is controlled by at least one thermal manipulator.

19. The optical element as claimed in claim 18, wherein
the optical element has the first surface shape at a manufacturing temperature.

20. An optical system for a semiconductor technology apparatus, comprising:
at least one optical element according to claim 18, and
at least one thermal manipulator which controls the mean operating temperature of the optical element.

21. The optical system according to claim 20, wherein
provision of a predetermined state in which the mean operating temperature of the optical element and the mean operating temperature of at least one further optical element deviate from one another by at least 1 K leads to a reduction of at least one aberration by at least 20% in comparison with a state in which the optical element and the at least one further optical element have at least substantially same temperatures.
